(19) United States
(12) Patent Application Publication
(10) Pub. No.: US 2010/0266802 A1
(43) Pub. Date: Oct. 21, 2010

(54) DECORATIVE SKIN FOR AN AIRBAG COVER

(75) Inventors: Klaus Hemmelmann, Odenthal (DE); Jeffrey Lindberg, Burscheid (DE)

Correspondence Address: BUTZEL LONG;IP DOCKETING DEPT, 350 SOUTH MAIN STREET, SUITE 300, ANN ARBOR, MI, 48104, US

(73) Assignee: JOHNSON CONTROLS INTERIORS GMBH & CO., KG, GRENFRATH (DE)

(21) Appl. No.: 12/808,098

(22) PCT Filed: Nov. 28, 2008
(86) PCT No.: PCT/EP08/10137

§ 371 Date: Jun. 14, 2010

(30) Foreign Application Priority Data
Dec. 13, 2007 (DE) 10 2007 060 584.8

(51) Int. Cl. B65D 65/28; B32B 38/04

(52) U.S. Cl. 428/43; 156/268

(57) ABSTRACT

The invention relates to a method for producing a decorative skin of an airbag cover having a weakened area, wherein a predetermined breaking groove is integrally formed into the decorative skin. The invention further relates to a decorative skin having a weakened area.

### CROSS REFERENCE TO RELATED APPLICATIONS

The present application is a U.S. National Phase filing of International Application No. PCT/EP2008/010137, filed on Nov. 28, 2008, titled “Decorative Skin For An Airbag Cover”, which claims priority to German Patent Application DE 10 2007 060 584.8, filed Dec. 13, 2007, the entire disclosures of which are incorporated herein by reference.

### BACKGROUND

The disclosure relates to a method of producing a decorative skin for an airbag cover with a weakened area, in which a predetermined breaking groove is molded into the decorative skin. The disclosure additionally relates to a decorative skin with a weakened area.

Decorative skins are used in the interior of motor vehicles, for example in the dashboard area, and may consist as a rule of a plastic material. These decorative skins include at least one predetermined breaking groove, which splits open on activation of an airbag located under the decorative skin, the decorative skin is configured such that the predetermined breaking groove is not visible even after the vehicle has been in use for many years. Decorative skins and the production thereof are disclosed for example in DE 100 01 246 B4, DE 100 06 483, DE 100 48 636 B4, DE 101 22 376 A1, DE 196 46 548 C2 and in WO 2006/065750 A1. The methods described therein for the production of decorative skins are however comparatively complex or the decorative skins do not have the desired long term stability and/or are not recyclable. Thus, there is a need in the art for a decorative skin that is cost effective, provides a decorative appearance, and tears apart upon activation of the airbag.

### SUMMARY

An advantage of the present disclosure invention is therefore to provide a method in which the decorative skin is provided with a reliable weakened area using simple means, which weakened area is not visible on the interior trim part provided therewith even after relatively long use, the decorative skin preferably being recyclable. A further advantage of the present disclosure is to provide a corresponding decorative skin.

A method of producing a decorative skin for an airbag cover with a weakened area is provided in which a predetermined breaking groove is molded or incorporated into the decorative skin. A plastic insert is inserted into the predetermined breaking groove during or after the molding-in or forming process.

Advantageously, the method according to the present disclosure is simple and economic to carry out. The resultant decorative skin tears reliably along the predetermined breaking groove on activation of an airbag and the decorative skin is stable in the long term, such that the predetermined breaking groove is not visible even after years of use in a vehicle. Since compatible plastic materials may also be used, the decorative skin is in this case recyclable.

Accordingly, the present disclosure relates to the decorative skin of an airbag cover with a weakened area. The decorative skin may be formed of plastic material, such as a polymeric material, or polyurethane. The decorative skin may be produced by Reaction Injection Molding (RIM). A predetermined breaking groove is molded or incorporated into this decorative skin. This molding-in may be effected for example as early as during the casting, injection molding or extrusion process and subsequent curing of the decorative skin or by compression molding with or without exposure to heat. The predetermined breaking groove may also be incorporated into the decorative skin after forming, for example by removing the decorative skin material in the region of the predetermined breaking groove. The predetermined breaking groove may have any desired profile and any desired cross sectional shape. The cross sectional shape may vary over the profile of the groove, or be constant over the entire groove profile.

According to the disclosure a plastic insert is inserted into this predetermined breaking groove, at least in part, or over the entire length thereof. This plastic insert provides support to the decorative skin to prevent the predetermined breaking groove from collapsing or being pushed in and thus becoming visible to the vehicle occupant. The plastic insert does not have a negative influence on the tearing open of the predetermined breaking groove. Because the decorative skin and the insert are both made from a plastics material, recycling is simplified. The insert for each predetermined breaking groove may be made from one piece or be pieced together. The individual pieces of the plastic insert may be joined together.

The plastic insert may be materially bonded and/or joined interlockingly and/or non-interlockingly to the predetermined breaking groove.

The plastic insert may be inserted into a mold and then the material of the decorative skin is loaded, or injected, into the mold, where it cures. During curing a material bond forms between the plastic insert and the material of the decorative skin.

In another embodiment of the present disclosure, the predetermined breaking groove is prefabricated and then the plastics insert is adhesively bonded and/or welded into the predetermined breaking groove.

The plastic insert may be pressed, or snapped, into the predetermined breaking groove. For this purpose, the cross section of the plastic insert is at least in part somewhat greater than the cross section of the predetermined breaking groove and/or snap-in means are arranged in the predetermined breaking groove and/or on the plastic insert, which ensure an interlocking and/or non-interlocking connection between the plastic insert and the predetermined breaking groove.

In another example the predetermined breaking groove is initially molded or incorporated into the decorative skin and then at least partially filled with the material of which the plastic insert consists. For this purpose, the plastic material of the insert is initially a liquid or a semi-liquid and then cures in the predetermined breaking groove.

In an example, production of the predetermined breaking groove and filling with the plastic insert take place in a mold. The mold may include a slide for this purpose, with which the predetermined breaking groove is firstly produced. The slide is then displaced, creating a cavity in the predetermined breaking groove, and then the cavity is filled with the material of the plastic insert, which then cures in the predetermined breaking groove. Filling with the material of the plastic insert may take place before or after complete curing of the decorative skin. The decorative skin may be removed from the mold before the material of the decorative skin and/or the material of the insert are completely cured. After or during removal of the decorative skin from the mold, the slide is displaced back into its initial position and a new decorative skin may be manufactured.

It is contemplated that the volume of the plastic insert may be selected to be smaller than the volume of the predetermined breaking groove.

The plastic insert may be made from a different material from the decorative skin. For example, the material of the plastic insert is a harder material than the material used for the decorative skin. The material for the plastic insert may be selected such that tear strength is reduced in the region of the weakened area but is sufficiently compression-proof to prevent collapse or pushing in of the weakened region. The weakened area is thus permanently invisible from the visible or outer side (A-side) of the interior trim part. The insert may be made from polypropylene, wherein adhesion to the decorative skin may be established by way of adhesion promoters.

The decorative skin may be backed with a foam at least in places. The foam may be arranged after the plastic insert has been arranged in the predetermined breaking groove.

The decorative skin may be formed on a backing that is adjacent the inner surface of the decorative skin.

The present disclosure also teaches a method of forming a decorative skin.

The present disclosure moreover also teaches a decorative skin with a weakened area, or predetermined breaking groove. A plastic insert is formed in a part of the predetermined breaking groove.

The disclosure made in relation to the method according to the disclosure applies equally to both decorative skins according to the invention.

The decorative skin according to the disclosure is simple and economic to produce, stable in the long term and easy to recycle.

The plastic insert may be materially bonded and/or joined interlockingly and/or non-interlockingly to the predetermined breaking groove.

The plastic insert may be U-shaped.

It is additionally contemplated that the plastic insert may cure in the predetermined breaking groove.

The decorative skin may have a foam layer, which is located adjacent the inner surface of the decorative skin.

In a further embodiment the decorative skin includes a backing layer adjacent the foam layer, into which a weakened area is molded or incorporated.

Other features and advantages of the present disclosure will be readily appreciated, as the same becomes better understood after reading the subsequent description taken in conjunction with the accompanying drawings.

### BRIEF DESCRIPTION OF THE FIGURES

FIGS. 1a-1c illustrate a method of forming the decorative skin according to the disclosure.

FIGS. 2a-2d illustrate a further embodiment of a method of forming the decorative skin according to the disclosure.

FIGS. 3a-3c illustrate a third embodiment of a method of the decorative skin according to the disclosure.

### DETAILED DESCRIPTION

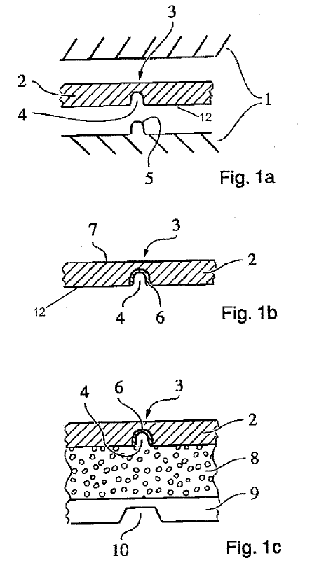

Referring to the method illustrated in FIG. 1, a method of forming a decorative skin is shown. The method includes a first step of forming a decorative skin 2 in a mold 1, for example by injection molding or compression molding. The decorative skin includes a decorative outer surface 7 and an opposed inner surface 12. The method includes the step of molding a weakened area 3 into the inner surface 12 of this decorative skin. For example, the weakened area may be in the form of a frame-like or U-shaped encircling groove 4. The groove may be formed by a complementary projection 5 on the mold 1 (FIG. 1a). The groove 4 does not extend up to the outer surface of the decorative skin, and is not visable in viewing the outer surface of the decorative skin. A plastic insert 6, such as the U-shaped insert of this example, is then inserted into the groove 4. The insert may for example take the form of an injection molded part or an extruded profile. The shape of the insert is complimentary to the shape of the groove 4. The joint formed between the decorative skin 2 and plastic insert 6 is such that the weakened area is preserved if the airbag is deployed, but the outer surface 7 is adequately supported. It may be sufficient simply to insert the plastic insert 6 into the groove 2 (FIG. 1b). In another example, the insert may be latched therein or adhesively bonded or welded therein, at least in places, to prevent flying particles. The inner surface of the decorative skin is may then be joined to the backing 9. A foam 8 layer may be disposed between the decorative skin 2 and the backing. The foam 8 may likewise be provided beforehand or afterwards with a weakened area as shown at 10.

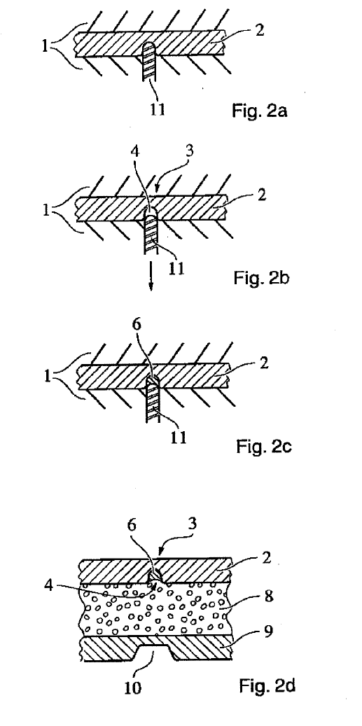

In the configuration illustrated in FIG. 2 the decorative skin 2 is formed in a mold having a slide member 11. The slide member 11 has a shape corresponding to the shape of the groove 4. The method includes the steps of first molding a groove 4 into the decorative skin 2 as shown in FIG. 2a by filling the mold with material and molding around the slide member 11. The mold material cures, and the slide is displaced from the mold as shown in FIG. 2b. After displacement of the slide member 11, a cavity produced thereby (groove 4 in FIG. 2b) is filled with another material. The other material is optionally also incompatible with the decorative skin 2, to produce the plastic insert 6 virtually filling the groove 4 as shown in FIG. 2c. The decorative skin may have a foam layer 8 and backing layer 9 secured thereto as previously described.

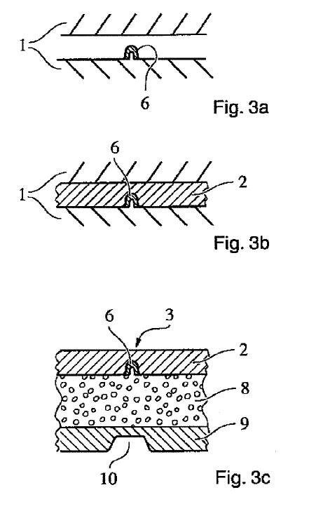

According to a further embodiment illustrated in FIG. 3, the method may also include the step of first inserting the prefabricated plastic insert 6 into the mold 1 (FIG. 3a). The method also include the step of filling the rest of the cavity with the material for the decorative skin 2 (FIG. 3b). In this manner, the insert is formed as one with the decorative skin 2. The foam layer 8 and backing layer 9 may then be formed thereon FIG. 3c as previously described.

The present disclosure has been described in an illustrative manner. It is to be understood that the terminology which has been used is intended to be in the nature of words of description rather than of limitation.

Many modifications and variations of the present disclosure are possible in light of the above teachings. Therefore, the present disclosure may be practiced other than as specifically described.

1. A method of producing a decorative skin to cover an airbag in a vehicle, said method including the steps of:
forming a predetermined breaking groove in the decorative skin, wherein the decorative skin includes an inner surface and an outer surface and the predetermined breaking groove is formed in the inner surface of the decorative skin;
inserting a plastics insert into the predetermined breaking groove to support the breaking groove such that a shape of the plastic insert corresponds to a shape of the predetermined breaking groove.

2. The method as set forth in claim 1, wherein the plastics insert is bonded to the predetermined breaking groove.

3. The method as set forth in claim 1, wherein the step of inserting a plastic insert further includes the step of inserting the plastics insert into a mold and then encapsulating the plastic insert with material to form the decorative skin.

4. The method as set forth in claim 1 further including the step of bonding the plastics insert into the predetermined breaking groove.

5. The method as set forth in claim 1 further including the step of pressing the plastics insert into the predetermined breaking groove to retain the plastic insert within the predetermined breaking groove.

6. The method as set forth in claim 1 wherein the predetermined breaking groove is at least partially filled with the plastics insert.

7. The method as set forth in claim 1 wherein the step of forming the predetermined breaking groove and inserting the plastics insert takes place in a mold.

8. The method as set forth in claim 7, wherein the step of forming the predetermined breaking groove further includes positioning a slide in the mold, filling the cavity with the plastic insert material and displacing the slide to form a cavity corresponding to the predetermined breaking groove.

9. The method as set forth in claim 1 wherein the volume of the plastics insert is selected to be smaller than the volume of the predetermined breaking groove.

10. The method as set forth in claim 1 wherein the plastics insert is made from a different material from the decorative skin.

11. The method as set forth in claim 1 further comprising the step of joining a foam layer to the inner surface of the decorative skin.

12. The method as set forth in claim 1 wherein the inner surface of the decorative skin is joined to a backing layer.

13. (canceled)

14. A decorative skin to cover an airbag in a vehicle having a weakened area through which the airbag is expelled comprising:
a predetermined breaking groove, formed within the decorative skin, wherein the decorative skin includes an outer surface and an inner surface and the breaking groove is positioned in the inner surface; and
a plastics insert disposed in the predetermined breaking groove.

15. The decorative skin as set forth in claim 14, wherein the plastics insert is bonded to the inner surface of the predetermined breaking groove.

16. The decorative skin as set forth in claim 14 wherein the plastics insert is U-shaped.

17. The decorative skin as set forth in claim 14 wherein the plastics insert is placed in a mold for the decorative skin and molded in place within the predetermined breaking groove.

18. The decorative skin as set forth in claim 14 further comprising a foam layer positioned adjacent the inner surface of the decorative skin.

19. The decorative skin as set forth in claim 18 further comprising a backing layer positioned adjacent the foam layer.

20. The decorative skin as set forth in claim 19 wherein the backing layer includes a weakened area.
